(19) United States
(12) Patent Application Publication
(10) Pub. No.: US 2025/0206939 A1
(43) Pub. Date: Jun. 26, 2025

(54) CURABLE SULFONATED POLYMER COMPOSITIONS

(71) Applicant: Notark Corporation, Houston, TX (US)

(72) Inventors: Roger Tocchetto, Houston, TX (US); Jiaqi Yan, Houston, TX (US); Vijay Mhetar, Houston, TX (US)

(73) Assignee: Notark Corporation, Houston, TX (US)

(21) Appl. No.: 19/047,833

(22) Filed: Feb. 7, 2025

Related U.S. Application Data
(63) Continuation-in-part of application No. 18/366,043, filed on Aug. 7, 2023.
(60) Provisional application No. 63/550,722, filed on Feb. 7, 2024.

(51) Int. Cl. C08L 53/00; B01J 39/05; B01J 39/20; B01J 47/12; C08J 5/22; C08K 3/22

(52) U.S. Cl. CPC C08L 53/005; B01J 39/05; B01J 39/20; B01J 47/12; C08J 5/2231; C08J 5/2275; C08K 3/22; C08J 2353/00; C08J 2471/02; C08K 2003/2213; C08L 2312/00

(57) ABSTRACT

The disclosure relates to a polymer membrane comprising a curable composition that includes: (a) a sulfonated hydrogenated styrenic block copolymer (SSBC); (b) hydroxyl group containing compound; (c) at least one cross-linking agent comprising an epoxy-based compound; and (d) optionally, a radical scavenger. The SSBC consists of at least one block “S” and at least one block “_{S}S,” each independently composed of vinyl aromatic units, and at least one block “R,” composed on hydrogenated diene units. The block “_{S}S” has a degree of sulfonation of at least 10 mol %. The SSBC has an ion exchange capacity (IEC) of at least 0.5 meq/g. Upon curing, the polymer membrane demonstrates improved proton conductivity and durability.

### RELATED APPLICATIONS

This application is a continuation-in-part of U.S. patent application Ser. No. 18/366,043, having a filing date of Aug. 7, 2023, incorporated herein by reference. This application also claims benefit to U.S. provisional application No. 63/550,722, filed on Feb. 7, 2024, incorporated herein by reference.

### FIELD

The present disclosure relates to curable sulfonated polymer compositions, methods of preparation, and applications thereof.

### BACKGROUND

Sulfonated polymer compositions have been used in various applications including polymer membranes. The performance of these polymer membranes largely depends on the materials employed. However, sulfonated polymer compositions that rely solely on sulfonated polymers face performance limitations in polymer membranes and related applications, such as batteries, fuel cells, electrolytes, binders, etc.

To enhance the performance of sulfonated polymer compositions across a wide range of applications, efforts have focused on modifying sulfonated polymers or blending them with other functional polymers. Improvements in the mechanical properties of these compositions have also been pursued by incorporating functional polymers and/or cross-linking agents.

There is still a need for a composition with improved mechanical properties, chemical stability, and durability for use in membrane applications.

### SUMMARY

In one aspect, the disclosure relates to a polymer membrane formed from a curable composition comprising, consisting essentially of, or consists of: (a) 60 to 98 wt. % of a sulfonated hydrogenated styrenic block copolymer (SSBC); (b) 1 to 20 wt. % of a hydroxyl group containing compound selected from the group consisting of diols, triols, tetraols, polyols, polymeric polyols, and mixtures thereof; (c) at least 1 wt. % of a cross-linking agent containing an epoxy-based compound; and (d) up to 5 wt. % of a radical scavenger. The SSBC comprises at least one block “S” and at least one block “_{S}S,” each independently composed of vinyl aromatic units, and at least one block “R” composed of hydrogenated diene units. The block “S” is resistant to sulfonation and the block “sS” is susceptible to sulfonation having a degree of sulfonation of at least 10 mol %. The SSBC has an ion exchange capacity (IEC) of at least 0.5 meq/g. The polymer membrane, after curing, retains a proton conductivity of >55% after aging in Fenton's reagent for 4 hours at 65° C., relative to the proton conductivity of the polymer membrane before aging, measured at 60° C.

In a second aspect, the polymer membrane has a weight gain of <70 wt. %, after immersion for 24 hours in DI water at 25° C., measured at 25° C.

In a third aspect, the polymer membrane has a weight gain of <350 wt. %, after immersion for 24 hours in DI water at 80° C., measured at 25° C.

In a fourth aspect, the polymer membrane has a retention of a proton conductivity of>60% after aging in Fenton's reagent for 4 hours at 65° C., relative to the proton conductivity of the polymer membrane before aging, measured at 60° C.

### DESCRIPTION

The following terms will be used throughout the specification.

“Consisting essentially of” means that the claimed composition primarily contains the specified materials, with allowances for additional components that do not materially affect novel characteristics or function of the claimed invention, with the additional components, if present, in an amount of <30%, or <20%, or <10%.

“At least one of [a group such as A, B, and C]” or “any of [a group such as A, B, and C]” means a single member from the group, more than one member from the group, or a combination of members from the group. For example, at least one of A, B, and C includes, for example, A only, B only, or C only, as well as A and B, A and C, B and C; or A, B, and C, or any other combinations of A, B, and C. In another example, at least one of A and B means A only, B only, as well as A and B.

A list of embodiments presented as “A, B, or C” is to be interpreted as including the embodiments, A only, B only, C only, “A or B,” “A or C,” “B or C,” or “A, B, or C.”

“Any of A, B, or C” refers to one option from A, B, or C.

“Any of A, B, and C” refers to one or more options from A, B, and C.

“Vinyl aromatic unit content” or VAC of a block copolymer refers to the weight % of polymerized vinyl aromatic monomers, e.g., styrene, para-methylstyrene, etc., in the block copolymer, calculated by dividing the sum of molecular weight of all vinyl aromatic units by total molecular weight of the block copolymer. VAC can be determined using proton nuclear magnetic resonance spectroscopy (¹H NMR) and ¹³C NMR. VAC sometimes is used interchangeably with PSC, or polystyrene content.

“Butylene unit content” refers to the content, in weight %, of the butylene units (“B”) in a hydrogenated block copolymer. The butylene units are obtained/formed by polymerization of 1,3-butadiene monomer via 1,2-addition, followed by hydrogenation. The 1,3-butadiene monomer can also polymerize through 1,4-addition, which upon hydrogenation results in ethylene units (“E”). Both butylene and ethylene units can be part of the hydrogenated block copolymer which can also contain vinyl aromatic units and ethylene-propylene units in any order in any order. The butylene unit content can be measured by ¹H NMR and ¹³C NMR.

“Molecular weight” or M_{w} refers to the polystyrene equivalent molecular weight in kg/mol or g/mol of a polymer block or a block copolymer. M_{w} can be measured with gel permeation chromatography (GPC) using polystyrene calibration standards, such as is done according to ASTM 5296-19. The GPC detector can be an ultraviolet or refractive index detector or a combination thereof. The chromatograph is calibrated using commercially available polystyrene molecular weight standards. M_{w} of polymers measured using GPC so calibrated are polystyrene equivalent molecular weights or apparent molecular weights. M_{w} expressed herein is measured at the peak of the GPC trace and are commonly referred to as polystyrene equivalent “peak molecular weight,” designated as Mₚ.

“HSBC” refers to a hydrogenated styrenic block copolymer. HSBC are selectively hydrogenated when a substantial proportion (e.g., >90%) of one type of unsaturated bonds, usually olefinic bonds originating from the conjugated diene units, are hydrogenated, while most (e.g., >90%) of other unsaturated bonds, usually aromatic bonds, are non-hydrogenated.

“Hydrogenation level” refers to the level (in %) of saturation of the double bonds (e.g., olefinic, aromatic, etc.) in a block copolymer, can be measured by ¹H NMR.

“Residual unsaturation” or RU refers to the level of olefinic unsaturation, i.e., carbon-carbon double bonds of a block copolymer, expressed in milliequivalent per gram (meq/g). One equivalent here is one mole of olefinic double bonds. RU can be measured using ¹H NMR or ozonolysis titration.

“Unit” refers to the structural building block derived from one monomer following its polymerization, representing a repeating entity that forms part of the polymer or copolymer chain. Unlike a “monomer,” which is the individual molecule before polymerization, a “unit” is the transformed version of the monomer after undergoing the polymerization process. A polymerized unit can be further transformed into a hydrogenated unit or a functionalized unit.

“Polydispersity index” or PDI refers to a ratio of a weight average molecular weight (M_{w}) to a number average molecular weight (Mₙ), sometimes also called as molecular weight distribution. PDI is used to indicate distribution of polymer chain molecular weights in a given polymer.

“Curing” refers to a process that creates a material by cross-linking, forming new bonds, and/or modifying existing bonds within monomers, oligomers, polymers, or their mixtures through thermal, radiation, or chemical methods. The term “cured” refers to a polymer that has undergone a curing or cross-linking process.

“Curable” as used herein, is interchangeable with “cross-linkable” and refers to a composition that can undergo curing.

“Diol,” “triol,” “tetrol,” and “polyol” refer to compounds containing 2, 3, 4, or more hydroxyl groups, respectively, and each with a molar mass of <0.5 kg/mol. In this context, “molar mass” refers to the molecular weight, defined as the total mass of a compound, calculated as the sum of the atomic masses of all atoms in the molecule (i.e., compound).

“Polymeric polyol” refers to a compound with a long-chain polymeric structure containing at least two hydroxyl groups, which can be located either at terminal positions or as pendant groups along the polymer backbone. The polymeric polyol can have a weight average molecular weight (M_{w}) of 0.5 to 30 kg/mol.

“Reactive agent” refers to a substance or compound, either organic or inorganic, that is introduced into a system to initiate a chemical reaction. It plays a crucial role in triggering the reaction and guiding the formation of the desired products. The selection of a reactive agent is based on its compatibility with the reaction conditions and the intended outcome of the chemical process.

“Metal cation” refers to a positively charged ion formed when a metallic element loses one or more electrons. The cation carries a positive charge because it contains more positively charged protons than negatively charged electrons in its structure.

“Sulfonated hydrogenated styrenic block copolymer” or SSBC refers to a hydrogenated styrenic block copolymer that contains sulfonic acid and/or sulfonate ester groups.

“Membrane” or “film” refers to a continuous, pliable sheet or layer of polymer material that acts as a selective barrier, allowing certain substances (e.g., molecules, ions, gases, particles, etc.) to pass through while blocking others.

“Susceptible to sulfonation” refers to a polymer, polymer block, compound, monomer, oligomer, or similar material that is predisposed or sensitive to reacting with sulfur containing compounds (e.g., SO₃, H₂SO₄, etc.) under sulfonation conditions, leading to the formation of a sulfonated product. In embodiments, a polymer block “susceptible to sulfonation” will exhibit a degree of sulfonation of at least 10 mol %, or at least 20 mol %, or at least 30 mol %, or at least 50 mol %, or at least 75 mol %, of the total polymer block. This results in the incorporation of at least 10 mol %, or 20 mol %, or 30 mol %, or 50 mol %, or 75 mol % sulfonic acid or sulfonate ester functional groups into the polymer, polymer block, compound, monomer, oligomer, etc.

“Resistant to sulfonation” means exhibiting little to no sulfonation of the respective block under conditions conventionally used for sulfonation, with <5 mol %, or <3 mol %, or <1 mol % sulfonic acid or sulfonate ester functional groups in the polymer block.

“Ion Exchange Capacity” or IEC refers to the total active sites or functional groups responsible for ion exchange in a polymer. Generally, a conventional acid-base titration method is used to determine the IEC, as detailed in the International Journal of Hydrogen Energy, Volume 39, Issue 10, Mar. 26, 2014, Pages 5054-5062, “Determination of the ion exchange capacity of anion-selective membrane.” IEC is the inverse of “equivalent weight” or EW, which is the weight of the polymer required to provide 1 mol of exchangeable protons.

“Dry” or “dry state” refers to or describes the state of hydration of the material or membrane which has absorbed essentially no or only insignificant amounts of water. For example, a material or membrane which is merely in contact with atmospheric moisture is considered to be in the dry state.

“Wet” or “wet state” refers to or describes the state at which the material or membrane has reached weight equilibrium with water or has been immersed in water or an aqueous solution for a pre-determined period, e.g., >5 minutes, or >1 hour, or >1 day, or >1 week, etc. The properties of the film such as “toughness in wet state” or “tensile stress in wet state,” etc., refer to the properties of the film tested while immersed in water or tested immediately upon retrieval from the conditioning aqueous environment.

“Gel content” refers to the insoluble fraction of a cured composition in a toluene: 1-propanol mixture (weight ratio of 1:1), expressed as a percentage of the cured composition (prior to immersing in the toluene: 1-propanol mixture). In embodiments, the gel content is >70% (i.e., the amount of composition dissolved in toluene: 1-propanol is <30%), or >80%, or >90%.

“Gel Content Test” refers to the measurement of a gel content by placing a sample of a cured composition with an initial weight (G1) in 20 times volume of a toluene: 1-propanol mixture (in a 1:1 weight ratio) at room temperature for a period until equilibrium is reached, e.g., 4 hours. The mixture is then filtered to recover the solid portion of the cured composition, which is dried to remove the solvent and weighed, yielding the insoluble content weight (G2). Gel content is calculated as (G2/G1).

“Weight gain” refers to a weight difference (W %) of a cured composition (e.g., film, membrane, etc.) before and after immersion in water for a specified period (e.g., 5 hours, or 1 day, or 1 week, or longer). Weight gain is calculated as:

$$W \% = \frac{W 2 - W 1}{W 1} \times 100$$

where W1 is the weight of the cured composition before immersion, and W2 is the weight after immersion. Weight gain is used interchangeably with water uptake or swelling and is expected to be as low as possible for optimal performance.”

The present disclosure relates to a polymer membrane comprising a curable composition that includes: (a) a sulfonated hydrogenated styrenic block copolymer (SSBC); (b) at least one hydroxyl group containing compound; (c) a cross-linking agent based on epoxy compounds; and (d) optionally, a radical scavenger. Upon curing, the polymer membrane demonstrates enhanced mechanical properties, chemical stability, durability, and proton conductivity.

(Sulfonated Hydrogenated Styrenic Block Copolymer (SSBC)): The SSBC is obtained by sulfonation of a hydrogenated styrenic block copolymer (HSBC) precursor which is any of triblock, tetrablock, pentablock structures, or mixtures thereof, and any of a linear or branched (multi-arm) block copolymer. The SSBC comprises at least one block “S” and at least one block “_{S}S”, each independently composed of vinyl aromatic units; and at least one rubbery block “R” (block “R”) composed of hydrogenated diene units and optionally vinyl aromatic units. The vinyl aromatic units are derived from polymerized vinyl aromatic monomers, while the hydrogenated diene units, prior to hydrogenation, are derived from polymerized diene monomers.

In embodiments, at least one block “S,” “sS,” or “R” comprises at least one sulfonic acid group, e.g., —SO₃, either in an acid form (e.g., —SO₃H, sulfonic acid, etc.) or a salt form (e.g., —SO₃Na). The sulfonate group can be in the form of metal salt, ammonium salt, or amine salt.

In embodiments, the SSBC is characterized as being sufficiently sulfonated, meaning having at least 10 mol % of sulfonic acid or sulfonate ester functional groups based on total mol of the number of monomer units or polymer blocks to be sulfonated (“degree of sulfonation”). In embodiments, block “sS” and/or block “R” has a degree of sulfonation of at least 10 mol %, or >15, or >20, or >25, or >30, or >40, or >50, or >60, or >70, or >80, or >90, or >99, or <100 mol %. The degree of sulfonation can be calculated by NMR or ion exchange capacity (IEC).

In embodiments, the block “S” is not sulfonated (i.e., resistant to sulfonation).

In embodiments, the HSBC precursor is prepared by anionic polymerization using techniques known in the art followed by hydrogenation. Other methods, such as cationic polymerization, can also be employed. The anionic polymerization initiator is generally an organometallic compound, such as an organolithium compound, e.g., ethyl-, propyl-, isopropyl-, n-butyl-, sec-butyl-, tert-butyl-, phenyl-, hexylbiphenyl-, hexamethylenedi-, butadieneyl-, isopreneyl-, 1,1-diphenylhexyllithium, or polystyryllithium. An amount of initiator needed is calculated based on the molecular weight to be achieved, generally from 0.002 to 5 wt. %, based on the amount of monomers to be polymerized. Suitable solvents include aliphatic, cycloaliphatic, or aromatic hydrocarbons having from 4 to 12 carbon atoms, such as pentane, hexane, heptane, cyclopentane, cyclohexane, methylcyclohexane, decalin, isooctane, benzene, alkylbenzenes, such as toluene, xylene, or ethylbenzene, or suitable mixtures thereof. Polymer chain termination can be achieved by quenching with a proton donor or a compound having a leaving group that can be displaced by the carbanionic polymer chain. A suitable catalyst based on nickel, cobalt or titanium can be used in the hydrogenation step.

In embodiments, the SSBC has a general structure of: S-_{S}S-S, (S-_{S}S)ₙ(S), (S-_{S}S-S)ₙ, (S-_{S}S-S)ₙX, (S-_{S}S)ₙX, S-_{S}S-R, S-R-_{S}S-R-S, S-_{S}S-R-_{S}S-S, (S-R-_{S}S)ₙS, (S-_{S}S-R)ₙS, (S-R-_{S}S)ₙX, (S-_{S}S-R)ₙX, (S-R-_{S}S-R-S)ₙX, (S-_{S}S-R-SS-S)ₙX, and mixtures thereof; wherein n is an integer from 2 to 30; and X is residue of a coupling agent. In embodiments, each block S is resistant to sulfonation, and each block “_{S}S” and “R” is susceptible to sulfonation.

In embodiments, the coupling agent includes bi-or polyfunctional compounds, for example divinylbenzene, halides of aliphatic or araliphatic hydrocarbons, such as 1,2-dibromoethane, bis (chloromethyl) benzene, or silicon tetrachloride, dialkyl-or diarylsilicon dichloride, alkyl-or arylsilicon trichloride, tin tetrachloride, alkylsilicon methoxides, alkyl silicon ethoxides, polyfunctional aldehydes, such as terephthalic dialdehyde, ketones, esters, anhydrides, or epoxides. In embodiments, the coupling agent is selected from methyltrimethoxysilane (MTMS), methyltriethoxysilane (MTES), tetramethoxysilane (TMOS), dimethyladipate, gamma-glycidoxypropyl-trimethoxy silane, and mixtures thereof. In embodiments, the HSBC precursor has a coupling efficiency (CE) of >10%, or >20%, or >90%, 10-100%, or 20-95%, or 70-95%, or 80-98%, or 85-95%.

In embodiments, block “S” is composed of vinyl aromatic units derived from para-substituted styrene monomers selected from the group consisting of para-methylstyrene, para-ethylstyrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene, and mixtures thereof. In embodiments, block “S” contains up to 15 wt. % of vinyl aromatic units such as those present in the block “sS”.

In embodiments, each block “S” has a Mₚ of 2-50, or 5-45, or 8-40, or 10-35, or 5-25, or >5, or <35 kg/mol. In embodiments, block “S” constitutes from 1-80, or 5-75, or 10-70, or 15-65, or 20-60, or 25-55, or 30-50, or >10, or <75 wt. %, based on total weight of the SSBC.

In embodiments, block “_{S}S” is composed of vinyl aromatic units derived from vinyl aromatic monomers selected from the group consisting of unsubstituted styrene, ortho-substituted styrene, meta-substituted styrene, alpha-methylstyrene, 1,1-diphenylethylene, 1,2-diphenylethylene, and mixtures thereof. In embodiments, the block “_{S}S” contains a mixture of the vinyl aromatic units and hydrogenated diene units.

In embodiments, each block “_{S}S” has a Mp of 5-200, or 10-150, or 15-100, or 5-50, or 10-40, or 15-30, or >5, or <80 kg/mol. In embodiments, block “_{S}S” constitutes from 10-80, or 15-75, or 20-70, or 25-65, or 30-55, or >10, or <75 wt. %, based on total weight of the SSBC. In embodiments, block “_{S}S” contains from 0-25, or 2-20, or 5-15 wt. %, of polymerized para-substituted styrene monomers such as those present in the block “S”.

In embodiments, the diene monomer is selected from the group consisting of isoprene, 1,3-butadiene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, and mixtures thereof.

In embodiments, block “R” has a Mp of 1-60, or 2-50, or 5-45, or 8-40, or 10-35, or 5-20, or >5, or <40 kg/mol. In embodiments, block “R” constitutes from 10-80, or 15-75, or 20-70, or 25-65, or >10, or <75 wt. %, based on total weight of the SSBC.

In embodiments, the SSBC has a butylene unit (“B”) content of 10-80, or 15-75, or 20-70, or 25-65, or 10-60, or 30-80, or >10, or <80 wt. %, based on total weight of hydrogenated diene units in the SSBC.

In embodiments, each block “S” and block “_{S}S” independently has a hydrogenation level of <30%, or <20%, or <10%, or <5%, based on double bonds present in the block “S” and “_{S}S”. In embodiments, diene units in each block “R” have a hydrogenation level of >50%, or >55%, or >60%, or >65%, or <90%, or 50-90%, or 55-85%, or 60-80%, or 65-90%, or 50-75%.

In embodiments, the HSBC precursor is sulfonated to provide the corresponding SSBC. Sulfonation occurs at the phenyl ring of polymerized styrene units in the block “_{S}S,” predominantly para to the phenyl carbon atom bonded to the polymer backbone. In embodiments, block “_{S}S” has a degree of sulfonation of 10-100, or 15-95, or 20-90, or 25-85, or 30-80, or 35-75, or 40-70, or >15, or <85 mol %, based on total mole of the block “_{S}S”.

In embodiments, the hydrogenated diene units in the block “R” has a degree of sulfonation of 10-100, or 15-95, or 20-90, or 25-85, or 30-80, or 35-75, or 40-70, or >15, or <85 mol %, based on total mole of the hydrogenated diene units.

In embodiments, the SSBC is a midblock-sulfonated pentablock copolymer, e.g., poly[tert-butylstyrene-b-(ethylene-propylene)-b-(styrenesulfonate)-b-(ethylene-propylene)-b-tert-butylstyrene] (tBS-EP-Ss-EP-tBS).

In embodiments, the SSBC has a Mₚ of 20-300, or 25-250, or 30-200, or 35-150, or 40-100, or 20-120, or 40-150, or >30, or <200 kg/mol.

In embodiments, the SSBC has an ion exchange capacity (IEC) of at least 0.5, or >0.75, or >1.0, or >1.5, or >2.0, or >2.5, or <5.0, or 0.5-3.5, or 1.0-3.0, or 0.5-2.6 meq of —SO₃H/g of the polymer, can be measured by ¹H NMR or ozonolysis.

In embodiments, the SSBC used in the curable composition is in amounts of 60-98, or 70-98, or 75-96, or 80-98, or 92-98, or 85-97 wt. %, based on total weight of the curable composition.

(Hydroxyl Group Containing Compounds): The hydroxyl group containing compound is selected from the group consisting of diols, triols, tetrols, polyols, polymeric polyols, and mixtures thereof.

Examples of diols, triols, tetrols, polyols include ethylene glycol, diethylene glycol, dipropylene glycol, triethylene glycol, 1,2-propanediol, tetraethylene glycol, 1,3-propanediol, 1,2-butanediol, 1-3-butanediol, 1,4-butanediol, 1,5-pentanediol, 1,6-hexanediol, 1,8-octanediol, 1,10-decanediol, 1,12-dodecanediol, 1,4-cyclohexanediol, 1,2-diphenol, 1,3-diphenol, 1,4-diphenol, 2-hydroxy-1,3-propanediol, neopentyl glycol, catechol, cyclohexenediol, 1,4-cyclohexanedimethanol, 3-methyl-1,5-pentanediol, 2-methyl-2-ethyl-1,3-propanediol, 2,2-diethyl-1,3-propanediol, 2,2,4-trimethyl-1,3-pentanediol, 1,4-dimethylolcyclohexane, trimethylolpropane, dimethyl-1,2-butanediol, tris(hydroxyethyl)isocyanurate, pentaerythritol, dipentaerythritol, glycerol, diglycerol, triglycerol, di-trimethylolpropane, 3-methyl-1,3-butanediol, 3,3-benzenetriol, 1,2,4-butanetriol, 1,2,6-hexanetriol, tris(methylalcohol)propane, tris(methylalcohol)ethane, tris(methylalcohol)nitropropane, 2,2-bis(methylalcohol)-1,3-propanediol, glycerin monostearate (glyceryl stearate), trihydroxyethylamine, butynediol, hexylene glycol, D-pantothenyl alcohol, caprylyl glycol, hydroquinone, 1-thioglycerol, erythorbate, butylated hydroquinone, calix [4] arene, ethylhexylglycerin, caprolactonediol, 1,2,3-propanetriol, hydroxyalkylated bisphenols, 1,2,4-butanetriol, 1,1,4-butanetriol, 1,3,5-pentanetriol, 1,2,5-pentanetriol, 2,3,4-pentanetriol, 1,2,3-hexanetriol, 1,2,6-hexanetriol, 1,3,4-hexanetriol, 1,4,5-hexanetriol, 2,3,4-hexanetriol, 1,2,3-heptanetriol, 1,2,4-heptanetriol, 1,2,6-heptanetriol, 1,3,5-heptanetriol, 1,4,7-heptanetriol, 2,3,4-heptanetriol, 2,4,6-heptanetriol, 1,2,8-octanetriol, 1,3,5-octanetriol, 1,4,7-octanetriol, butane-1,1,1-triol, 2-methyl-1,2,3-propanetriol, 5-methylhexane-1,2,3-triol, 2,6-dimethyl-3-heptene-2,4,6,-triol, benzene-1,3,5-triol, 2-methyl-benzene-1,2,3-triol, 5-methyl-benzene-1,2,3-triol, 2,4,6,-trimethylbenzene-1,3,5-triol, naphthalene-1,4,5-triol, 5,6,7,8-tetrahydro naphthalene-1,6,7-triol, 5-hydromethylbenzene-1,2,3-triol, 5-isopropyl-2-methyl-5-cyclohexene-1,2,4-triol, 4-isopropyl-4-cyclohexene-1,2,3-triol, 1,2,3,4-butanetetraol, 1,2,3,4-pentanetetraol, 1,2,4,5-pentanetetraol, 1,2,3,4-hexanetetraol, 1,2,3,5-hexanetetraol, 1,2,3,6-hexanetetraol, 1,2,4,5-hexanetetraol, 1,2,4,6-hexanetetraol, 1,2,5,6-hexanetetraol, 1,3,4,5-hexanetetraol, 1,3,4,6-hexanetetraol, 2,3,4,5-hexanetetraol, 1,2,6,7-heptanetetraol, 2,3,4,5-heptanetetraol, 1,1,1,2-octanetetraol, 1,2,7,8-octanetetraol, 1,2,3,8-octanetetraol, 1,3,5,7-octanetetraol, 2,3,5,7-octanetetraol, 4,5,6,7-octanetetraol, 3,7-dimethyl-3-octene-1,2,6,7-tetraol, 3-hexyne-1,2,5,6-tetraol, 2,5-dimethyl-3-hexyne-1,2,5,6-tetraol, dodecahydroxycyclohexane, anthracene-1,4,9,10-tetraol, arabitol, maltitol, mannitol, ribitol, sorbitol, xylitol, threitol, galactitol, isomalt, iditol, lactitol sorbitol, and mixtures thereof.

In embodiments, each diol, triol, tetrol, and polyol independently has a molar mass of <0.5, or <0.45, or >0.05, or 0.05-0.5, or 0.05-0.45, or 0.06-0.48, or 0.07-0.45 kg/mol.

Examples of polymeric polyols include polyether polyols, polyester polyols, polyester-polyether polyols, polycarbonate polyols, polycaprolactone polyols, acrylic polyols, polyether polycarbonate polyols, and mixture thereof.

In embodiments, the polymeric polyol is a polyether polyol selected from the group consisting of polyethylene glycol, polypropylene glycol, polybutylene glycol, polytetramethylene glycol, polyethylene glycol ester, polyethylene glycol diester, di-2-ethylhexyl polyethylene glycol ester, polyglycoldiglycidyl ether, polypropylene glycol ester, polyethylene glycol glyceride, polyethylene glycol propionaldehyde, poly(ethylene glycol) acrylate, poly(ethylene glycol) methacrylate, poly(ethylene glycol) dimethacrylate, polytetrahydrofuran polyether polyol, polycaprolactone diol, and mixtures thereof.

In embodiments, the polyether polyol can be random, or block copolymer obtained from blends or sequential addition of two or more alkylene oxides. In embodiments, the polyether polyol includes the alkylene oxide addition products of polyhydric alcohols such as ethylene glycol, propylene glycol, dipropylene glycol, trimethylene glycol, 1,2-butanediol, 1,5-pentanediol, 1,6-hexanediol, 1,7-heptanediol, hydroquinone, resorcinol, glycerol, 1,1,1-trimethylolpropane, 1,1,1-trimethylolethane, pentaerythritol, 1,2,6-hexanetriol, alpha-methyl glucoside, sucrose, sorbitol, and mixtures thereof.

In embodiments, the polymeric polyol is a polyester polyol selected from the group consisting of polyethylene glycol butyrate, polyethylene glycol glutarate, polyethylene glycol adipate, polypropylene glycol butyrate, polypropylene glycol glutarate, polypropylene glycol adipate, polycaprolactonediol, polyhexamethylene adipate, polyhexamethylene sebacate, polyhexamethylene dodecanate, poly(ethylene adipate), polybutylene adipate, polyester polyol from isophthalic acid and diethylene glycol (IPA-DEG polyol), polyester polyol from isophthalic acid, diethylene glycol, 2-methyl-1,3-propanediol (IPA-DEG-MPD polyol), polyester polyol from terephthalic acid and diethylene glycol (TPA-DEG polyol), polyester polyol from terephthalic acid, diethylene glycol, and 2-methyl-1,3-propanediol (TPA-DEG-MPD), and mixtures thereof.

In embodiments, the polymeric polyol has a weight average molecular weight (M_{w}) of 0.5-30, or 0.6-25, or 0.7-22, or 0.8-20, or 0.9-18, or 1-15, or 0.5-5, or 0.5-3, or 0.8-2.5 kg/mol.

In embodiments, the hydroxyl group containing compound is added in amounts of 1-20, or 3-20, or 2-15, or 3-12, or 1-10 wt. %, based on total weight of the curable composition.

(Cross-linking Agents): The cross-linking agent is selected from the group consisting of acrylates; di or multivinylarene compounds; di or multiisocyanates; mono-, di-, or multianhydrides; silanes; epoxides; peroxides; primary, secondary, or tertiary amines, diamines or multiamines; amides; aldehydes; halides of aliphatic or araliphatic hydrocarbons; siloxanes; polyether modified siloxanes; thiols; and mixtures thereof.

In embodiments, the cross-linking agent comprises one or more epoxy-based compounds. Examples include glycidyl p-vinylbenzoate, glycidyl o-vinylbenzoate, glycidyl m-vinylbenzoate, glycidyl p-vinylphenylacetate, glycidyl o-vinylphenylacetate, glycidyl m-vinylphenylacetate, 1,2,3,4-diepoxybutane, 1,2,7,8-diepoxyoctane, 1,2-bis(2,3-epoxypropyl)-2,3-ethylene, N,N,N′,N′-tetraglycidyl-n-xylenediamine, 4,4′-methylenebis(N,N-diglycidylaniline), 3,4-epoxycyclohexylmethyl-3,4-epoxycyclohexanecarboxylate, 7-oxabicyclo[4.1.0]hept-3-ylmethyl 7-oxabicyclo[4.1.0]heptane-3-carboxylate), epichlorohydrin, polyepichlorohydrin, 1,3-butanediene diepoxide, diglycidyl-, triglycidyl-or polyglycidyl-ester of a carbohydrate, diglycidyl ester of salicylic acid, vanillic acid, or 4-hydroxybenzoic acid, N,N-bis(2,3-epoxypropyl) aniline, p-(2,3-epoxypropoxy-N,N-bis(2,3-epoxypropyl) aniline, 1,3-bis(N,N′-diglycidylaminomethyl) cyclohexane, N,N,N′,N′-tetraglycidyl-m-xylylenediamine, mono- or multifunctional epoxy silanes, epoxidized oil, and mixtures thereof.

In embodiments, the cross-linking agent is a glycidyl ether selected from the group consisting of monoglycidyl ether, diglycidyl ether, triglycidyl ether, tetraglycidyl ether, pentaglycidyl ether, hexaglycidyl ether, octaglycidyl ether, polyglycidyl ether, and mixtures thereof. Examples of glycidyl ethers include o-vinylbenzyl glycidyl ether, vinylphenyl glycidyl ether, m-vinylbenzyl glycidyl ether, p-vinylbenzyl glycidyl ether, trimethylpropane triglycidyl ether, pentaerythritol triglycidyl ether, pentaerythritol tetraglycidyl ether, glycerol triglycidyl ether, sorbitol triglycidyl ether, sorbitol tetraglycidyl ether, diglycerol triglycidyl ether, tris(4-hydroxyphenyl)methane triglycidyl ether, glycerol triglycidyl ether, diglycidyl-, triglycidyl- or polyglycidyl-ether of a carbohydrate, diglycidyl-ether of salicylic acid, diglycidyl ether of bis-hydroxymethylfuran, and mixtures thereof.

In embodiments, the diglycidyl ether is selected from any of bisphenol F diglycidyl ether (BFDGE), ethylene glycol diglycidyl ether (EGDGE), resorcinol diglycidyl ether, 1,4-butanediol diglycidyl ether, diglycidyl ether, 1,3-diglycidyl glyceryl ether, 2,2-bis[4-(glycidyloxy) phenyl]propane, resorcinol diglycidyl ether, neopentyl glycol diglycidyl ether, ethyleneglycol diglycidyl ether, propyleneglycol diglycidyl ether (PGDGE), diethyleneglycol diglycidyl ether, hexanediol diglycidyl ether, triethyleneglycol diglycidyl ether, dipropyleneglycol diglycidyl ether, tripropyleneglycol diglycidyl ether, polypropyleneglycol diglycidyl ether, diglycidylether of cyclohexane dimethanol, and isosorbide diglycidyl ether.

In embodiments, the acrylate based cross-linking agent is epoxy acrylates selected from glycidyl acrylate, glycidyl methacrylate, glycidyl cyanoacrylate, glycidyl α-ethylacrylate, glycidyl α-n-propylacrylate, glycidyl α-n-butylacrylate, 3,4-epoxybutyl acrylate, 3,4-epoxybutyl methacrylate, 6,7-epoxyheptyl acrylate, 6,7-epoxyheptyl methacrylate, 6,7-epoxyheptyl α-ethylacrylate, 3,4-epoxycyclobexyl acrylate, 3,4-epoxycyclohexylmethyl methylmethacrylate, 2,3-epoxycyclohexyl acrylate, 2,3-epoxycyclohexyl methacrylate, and mixtures thereof.

Examples of other cross-linking agents include glycidyl amine, diglycidyl amine, triglycidyl amine, polyglycidyl amine, glycidyl amide, diglycidyl amide, triglycidyl amide, polyglycidyl amide, glycidyl ester, diglycidyl ester, triglycidyl ester, polyglycidyl ester, glycidyl azide, diglycidyl azide, triglycidyl azide, polyglycidyl azide, tris(2,3-epoxypropyl) isocyanurate, 1,3,5-tris-(2,3-epoxybutyl)-isocyanurate, 1,3,5-tris-(3,4-epoxybutyl)-isocyanurate, 1,3,5-tris-(4,5-epoxypentyl)-isocyanurate, triethylenediamine, N,N-dimethylcyclohexylamine, N,N-dimethylethanolamine, N-methylmorpholine, 2,2′-dimorpholinodiethylether, bis(2-dimethylaminoethyl)ether, N,N,N′-trimethylaminoethylethanolamine, N,N,N′,N′-tetramethyl-1,6-hexanediamine, 1,3,5 tris(dimethylaminopropyl)-hexahydro-s-triazine, 1,8-diazabicyclo-5,4,0-undecene-7, N-(3-aminopropyl)imidazole, 1,2-dimethylimidazole, 4-4′-trimethylenebis(1-methylpiperidine), and mixtures thereof.

In embodiments, the cross-linking agent is used in amounts of at least 1 wt. %, or 1-15, or 1-10, or 3-12, or 1-8, or <12 wt. %, based on total weight of the curable composition.

(Optional Radical Scavengers): In embodiments, the curable composition further comprises a radical scavenger containing an antioxidant compound. The radical scavenger mitigates the detrimental effects of oxidative processes by neutralizing free radicals. Suitable radical scavengers include phenolic compounds, hindered amine light stabilizers, phosphites, phosphonites, quinones, amines, thioesters, metal-based compounds, and mixtures thereof.

In embodiments, the radical scavenger is a metal based compound selected from the group consisting of tungsten (W), ruthenium (Ru), palladium (Pd), silver (Ag), rhodium (Rh), cerium (Ce), zirconium (Zr), yttrium (Y), manganese (Mn), molybdenum (Mo), lead (Pb), vanadium (V), titanium (Ti), their ionic form, their oxide form, their salt form, and mixtures thereof. Examples of radical scavengers include RuO₂, WO₃, FeO₄, CrPO₄, AlPO₄, FePO₄, FeF₃, ZrO₂, MnO₂, Al₂O₃, Vo, Fe-porphyrin, Co-porphyrin, and mixtures thereof.

In embodiments, the radical scavenger is cerium which has any valence state of Ce²⁺, Ce³⁺, Ce⁴⁺, or mixtures thereof. The radical scavenger based on cerium compounds can be of a general formula Ce-M-O, wherein M is a metal element other than Ce, e.g., Nb, Ta, Si, Ga, Sn, W, Dy, In, Zr, Ti, Mo, etc.

Examples of the cerium compound as the radical scavenger include CeO₂, CePO₄, CeF₃, CeO₂-ZrO₂, Ce₃TaO₇, Ce₂Zr₂O₇, Ce₂Ti₂O₇, Ce₂TiO₅, Ce₂WO₆, Ce₂Si₂O₇, CeTa₃O₉, Ce₂MO₄O₁₅, CeTaO₄, CeNb₃O₉, CeNbO₄, Ce₂(CO₃)₃·8H₂O, Ce(CHCOO)₃·H₂O, Ce(NO₃)₆·6H₂O, Ce(NH₄)₂(NO₃)₆, Ce(NH₄)₄(SO₄)₄·4H₂O, CeCl₃·6H₂O Ce(CH₃COCHCOCH₃)₃·3H₂O, and mixtures thereof.

Examples of other radical scavengers include a-tocopherol, hydroquinone, 2,2-bipyridine, 2,6-dimethoxy-1,4-benzoquinone, quercetin, ferrocyanide, cinnamic acid, terephthalic acid, alizarin, fluoroalkyl phosphonic acids, and mixtures thereof.

In embodiments, the radical scavenger has an average size of <100 nm, or <50 nm, or <30 nm, or <20 nm, <10 nm, or <5 nm, or >0.01 nm.

In embodiments, the radical scavenger is used in amounts of up to 5 wt. %, or 0.01-5, or 0.05-4, or 0.1-3, or 0.01-2, or 0.05-1.5 wt. %, based on total weight of the curable composition.

(Optional Reactive Agent): In embodiments, instead of or in addition to a cross-linking agent, the curable composition comprises at least one reactive agent selected from the group consisting of organic acids, inorganic acids, isocyanates, and mixtures thereof.

Examples of reactive agents include hydrogen chloride, hydrogen bromide, hydrogen fluoride, sulfuric acid, nitric acid, phosphoric acid, titanium tetrachloride, zirconium tetrachloride, aluminum trichloride, boron trifluoride, thionyl chloride, thionyl bromide, benzoyl chloride, isophthaloyl dichloride, terephthaloyl dichloride, ortho-phthaloyldichloride, 4-nitrobenzoyl chloride, formic acid, acetic acid, trifluoroacetic acid, methanesulfonic acid, oxalyl chloride, acetyl chloride, butyryl chloride, stearoyl chloride, p-toluene sulfonic acid, p-toluene sulphonyl chloride, n-benzyl-n-phenylcarbamoyl chloride, n-methyl-n-phenylcarbamoyl chloride, butylcarbamyl chloride, diphenylchloromethane, phosgene, triphosgene, carbonyldiimidazole, phosphorus oxychloride, phosphorus trichloride, phosphorus pentachloride, sulfonyl chloride, benzenesulfonyl chloride, aluminum tert-butoxide, triethylaluminim, zinc chloride, 2,4-toluene diisocyanate, 2,6-toluene diisocyanate, 1,6-hexamethylenediisocyante, aluminum ethoxide, 4,4′-methylenediphenyl diisocyanate, and mixtures thereof.

In embodiments, the reactive agent, if used, is in amounts of 0.001-10, or 0.05-5, or 0.1-5 wt. %, based on total weight of the curable composition.

(Optional Additives): In embodiments, the curable composition further comprises at least an additive selected from the group consisting of initiators, activators, curing agents, stabilizers, neutralizing agents, thickeners, coalescing agents, slip agents, release agents, anti-microbial agents, surfactants, antioxidants (other than listed above under radical scavengers), antiozonants, color change pH indicators, plasticizers, tackifiers, film forming additives, dyes, pigments, UV stabilizers, UV absorbers, catalysts, fillers, fibers, flame retardants, viscosity modifiers, wetting agents, deaerators, toughening agents, adhesion promoters, colorants, heat stabilizers, lubricants, drip retardants, anti-blocking agents, anti-static agents, processing aids, stress-relief additives, and mixtures thereof.

In embodiments, the additive is added in amounts of up to 10, or 0.1-10, or 1-10, or 0.5-5 wt. %, based on total weight of the curable composition.

In embodiments, the curable composition further includes polymers in addition to the SSBC. Examples of these polymers include polytetrafluoroethylenes (PTFEs), polyolefins, polyimides, polyamides, polyesters, polystyrenes, polysulfones, polyketones, polyphenylene ethers, polyisoprenes, polybutadienes, polyvinylidene fluorides, polycarbonates, polyetherimides, ethylene-vinyl alcohol copolymers, polyvinylidene chlorides, polyacrylates, polytertbutylstyrene, and mixtures thereof. One or more of these polymers can be included in amounts ranging from 1-30, or 2-25, or 5-20 wt. %, based on total weight of the curable composition.

(Curable Compositions): In embodiments, the curable composition, based on total weight, comprises: (a) 60-98 wt. % of a SSBC, (b) 1-20 wt. %, of at least one hydroxyl group containing compound, (c) ≥ 1 wt. % of a cross-linking agent, and (d) up to 5 wt. % of a radical scavenger; alternatively: (a) 75-96 wt. % of SSBC, (b) 3-12 wt. %, of at least one hydroxyl group containing compound, (c) 1-10 wt. % of a cross-linking agent, and (d) up to 5 wt. % of a radical scavenger.

(Methods of Preparation of Curable Compositions): The curable composition can be prepared by mixing the components in a solvent or a mixture of solvents to obtain a dispersion or solution. Examples of solvents include cyclopentane, cyclohexane, cycloheptane, cyclooctane, hexane, heptane, nonane, decane, paraffinic oil, methanol, ethanol, propanol, butanol, methyl-tert-butyl ether, tetrahydrofuran, dioxan, ethyl acetate, dimethylsulfoxide, dimethylformamide, toluene, xylene, and mixtures thereof.

In embodiments, the curable composition is prepared by adding the components to a mixture of solvents, e.g., toluene: 1-propanol, cyclohexane: heptane, or cyclohexane: 1-propanol. The solvent mixture can be two solvents in a weight ratio of 1:10 to 10:1, or 1:8 to 8:1, or 1:6 to 6:1, or 1:2 to 2:1 or 1:1. The concentration of the curable composition in the solvent(s) can be from 2-30%, or 5-20%, or >2%, or >5%, or >10%, or >15%, based on total weight of the dispersion/solution and desired final solution viscosity for the subsequent process. In embodiments, the concentration of the curable composition is in the range of 10-20% in toluene: 1-propanol mixture (weight ratio of 1:1), for a solution viscosity of 1.8-2.2 or 1.9-2.1 Pa.s.

In embodiments, the dispersion/solution is subjected to heating at a temperature of 20° C. to the boiling point of the employed solvent(s) or above, or 20-100° C., or 25-95° C., or 30-90° C., or 35-85° C., or >35° C., or <80° C., and for sufficient time in the range of 1 minute-24 hours, or 5 minutes-2 hours, or 10 minutes-1 hour, or 20 minutes-40 minutes, or >5 minutes, or <1 hour, with or without agitation, to obtain a homogenous dispersion/solution.

In embodiments, the components are mixed together at once, or separately mixed (in sequence) in the solvent(s) for a dispersion/solution. After the composition is prepared, depending on the end-use applications, the dispersion/solution is made into articles, e.g., films or membranes, before curing.

In embodiments, the polymer membrane (or membrane) is prepared from the curable composition by any of casting, electrospinning, extrusion, compression, coating, such as dipping, flow coating, roll coating, bar coating, spray coating, curtain, rotogravure, brushing, wire wound rod coating, pan fed reverse roll coating, nip-fed coating, spraying, knife coating, spin coating, immersion coating, slot-die coating, ultrasonic spray coating, and the like. The membrane can be stand-alone or supported on a substrate, e.g., glass, plastic, ceramic, porcelain, etc. The membrane after preparation, can be dried at a temperature of 80-120° C., or 90-125° C., to remove remaining solvent(s).

In embodiments, the membrane has a multilayer structure having two or more membranes stacked together, with each membrane in the multilayer structure being same or different in terms of thickness and composition.

(Cured Compositions/Articles): In embodiments, after an article (e.g., a

membrane, a film, etc.) is formed from the curable composition, the article is cured by radiation or thermal energy. Curing can be done by any of heat, UV radiation, gamma radiation, electron-beam (E-beam), or in microwave, in the presence or absence of a thermal/photo initiator. Curing can result in cross-linking of components of the curable composition.

In embodiments, curing of the membrane is conducted at 70-200° C., or 90-180° C., or 100-160° C., or >100° C., or <180° C. for 10 minutes-24 hours, or 20 minutes-20 hours, or 20 minutes-1 hour, or 1 hour-18 hours. After curing, the membrane is used for various tests.

In embodiments, the membrane, after curing, has a thickness of 1-400 μm, or 2-200 μm, or 5-100 μm, or 20-80 μm, or >5 μm, or <75 μm.

In embodiments, a composite membrane is prepared by coating the curable composition on to a microporous substrate followed by curing of the membrane on the substrate.

In embodiments, a membrane obtained from the curable composition and after curing, is heat laminated, solvent laminated, or adhesive laminated onto the microporous substrate.

Examples of the microporous substrate include polyolefin (e.g., PE, PP, PB, LDPE, HDPE, etc.), polysulfone, polyimide, polytetrafluoroethylene, polyetheretherketone, polyamideimide, polyester, cellulose, cellulose nitrate, cellulose acetate, a fibrous woven or a non-woven material, polytetrafluoroethylene, etc.

In embodiments, the microporous substrate further comprises a filler selected from the group consisting of inorganic oxides, carbonates, hydroxides, and mixtures thereof. Examples of fillers include alumina, silica, zirconia, titania, mica, boehmite, magnesium hydroxide, calcium carbonate, hydrotalcites, and mixtures thereof.

In embodiments, the microporous substrate has a thickness of 1-25 μm, or 5-20 μm, or <25 μm, or <20 μm. A thickness of total composite membrane can be in the range of <30 μm, or <25 μm, or 2-30 μm, or 5-25 μm.

(Alternative Embodiment): In embodiments, instead of or in addition to adding the hydroxyl group containing compound and the epoxy-based compound, a polymer membrane is formed from a composition comprising a SSBC and a metal cation. The membrane can be subsequently cured via chemical crosslinking. The metal cation is selected from the group consisting of divalent metal cations, trivalent metal cations, polyvalent metal cations, and mixtures thereof.

Metals in the metal cations can be selected from the group consisting of Mg, Ca, Zn, Cu, Co, Fe, Cr, Mn, Co, Sr, V, Ti, Sr, Ni, Al, Cr, Ba, Sn, Au, Pb, Pt, Ta, Tb, Tm, Ce, Dy, Er, Eu, La, Nd, Pr, Lu, Yb, Bi, Hf, Ho, Sm, and mixtures thereof.

Examples of metal cations include calcium acetate, calcium sulfate, calcium sulfite, calcium thiosulfate, calcium perchlorate, calcium chlorate, calcium chlorite, calcium hypochlorite, calcium carbonate, calcium bicarbonate, calcium chloride, calcium bromide, calcium hydroxide, calcium iodide, calcium nitrate, calcium phosphate, calcium pyrophosphate, calcium thiocyanate, ferric (meth)acrylate, calcium (meth)acrylate, aluminum (meth)acrylate, magnesium (meth)acrylate, ferric acetate, calcium acetate, aluminum acetate, magnesium acetate, ferric trifluoroacetate, calcium trifluoroacetate, aluminum trifluoroacetate, magnesium trifluoroacetate, ferric chloride, calcium chloride, aluminium chloride, magnesium chloride, ferric sulfate, aluminium sulfate, magnesium chloride, magnesium acetate, magnesium nitrate, iron (III) oxide-hydroxide, aluminium hydroxide, and mixtures thereof.

In embodiments, the polymer membrane is prepared by dissolving the SSBC in a suitable solvent, casting the solution into a film, and drying it to remove the solvent. The resulting film can either be free-standing or supported on a microporous substrate. An aqueous solution of a metal cation salt, with a concentration ranging from 0.1 to 3 molarity, is then prepared. The SSBC film is immersed in this solution for a period of 5 minutes to 24 hours, leading to the formation of the polymer membrane. The introduction of metal cations promotes chemical cross-linking of the sulfonic acid or sulfonate ester functional groups in the SSBC via ionic complexation.

In embodiments, the sulfonate group in the SSBC (in the membrane) is reacted with the metal cation in a level of 15-60%, or 18-50%, or 20-40%, based on total available sulfonate group in the SSBC.

(Properties): The membrane, after curing (or chemically cross-linked with the addition of the metal cation), exhibits elasticity and an excellent balance of low swell, high water vapor transmission rate (WVTR), and dimensional stability. It offers desirable water and ion transport characteristics, methanol resistance, barrier properties, controlled flexibility, adjustable hardness, and thermal/oxidative stability. Additionally, it possesses antimicrobial and antifouling properties. The membrane is sufficiently flexible to be rolled, screwed in both dry and wet conditions, cut, and meshed without breaking or deforming.

All properties are measured on the membrane after curing (cured membrane or membrane).

In embodiments, the membrane has a toughness in dry state of 3-25, or 4-22, or 5-20, or 6-18 MJ/m3. The toughness goes down slightly after being in wet state for 1 week (at 25° C. in deionized (DI) water), of 0.5-5, or 0.7-4, or 0.9-3 MJ/m³, measured at 25° C. after taking out from water. Measurements are per ASTM D412.

In embodiments, the membrane has a Young's modulus in dry state of 300-900, or 350-850, or 400-800, or 500-750 MPa, and a Young's modulus in wet state (at 25° C. in DI water) of 300-800, or 400-700, or 500-650 MPa, measured after 10 days at 25° C. after taking out from water. Measurements are per ASTM D412.

In embodiments, the membrane has an elongation at break in dry state of 1-250%, or 2-150%, or 5-50%. The membrane has an elongation at break in wet state (at 25° C. in DI water) measured after 10 days, of 1-150%, or 5-100%, or 10-50%, measured at 25° C. after taking out from water. Measurements are per ASTM D412.

In embodiments, the membrane has a Gel Content of >70%, or >75%, or >80%, or 70-95%, or 75-90%.

In embodiments, the membrane has a weight gain of <70, or <65, or <60, or <50, or <40, or <30, or >5, or 5-70, or 10-65, or 15-60, or 5-40, or 10-35, or 15-30 wt. %, after immersion for 24 hours in DI water at 25° C., measured at 25° C.

In embodiments, the membrane has a weight gain of <350, or <330, or <150, or >50, or 50-350, or 60-150, or 70-120, or 60-100 wt. %, after immersion for 24 hours in DI water at 80° C., measured at 25° C.

In embodiments, the membrane has an IEC of 0.7-2.5, or 0.8-2.4, or 1.0-2.3, or 1.1-2.2, or 0.8-2.10, or >0.7, or <2.3 meq/g.

In embodiments, the membrane has a water vapor transfer rate (WVTR) measured according to ASTM E96 in an upright or upside down manner at 50° C. and at 10% of relative humidity. In embodiments, the WVTR in an upright manner is 6000-9900, or 6500-9800, or 7000-9700, or 7500-9600, or 8000-9500 g/m²·day. In embodiments, the WVTR in an upside down manner is 50000-150000, or 60000-140000, or 65000-120000, or 70000-110000 g/m²·day.

In embodiments, the membrane has a retention of a proton conductivity of >65%, or >60%, or >55%, or >40%, or >30% after aging in Fenton reagent for 2 hours at 65° C.

In embodiments, the membrane has a retention of a proton conductivity of >80%, or >75%, or >70%, or >65%, or >60%, or >55% after aging in Fenton reagent for 4 hours at 65° C. Proton conductivity is measured at 60° C. in DI water using four probe electrochemical impedance spectroscopy on the membrane having a thickness of 60 μm.

In embodiments, the membrane after aging in Fenton reagent at 65° C., has a stability of >10 hours, or >8 hours, or >6 hours. Stability evaluation of the membrane is made via visual observation of the membrane in the Fenton reagent. “Broken” refers having sample in broken pieces, “Unstable” means the sample breaks up during handling, and “Stable” means the membrane sample remains intact.

In embodiments with a membrane obtained from the composition containing SSBC and metal cation, after chemically-crosslinked, the membrane has a tensile strength of 15-30, or 16-28, or 15-25 MPa.

(Applications): The membrane can be used in energy storage applications, electrical capacitors, super capacitors, coatings for cleanroom workwear and numerous medical applications such as wound dressings, surgeons' gowns, drapes and other biologically protective garments or barrier covers where moisture-vapor permeability is useful, and elasticity is desirable.

The membrane can be a microfiltration membrane, an ultrafiltration membrane, or a nanofiltration membrane and used in fuel cell, flow battery, solar hydrogen generator, device for energy storage, membrane capacitive deionization (MCDI), ion exchange membranes (anion and/or cation), for reverse or forward electrodialysis, for controlling humidity, separation cell (electrolyte barrier) for metal recovery processes, forward or reverse osmosis, for electro-or capacitive deionization, or for purifying or detoxifying gases or liquids, for waste water treatment, air condition (AC) dehumidification, desalinator, sensor, demineralization of water, ultra-pure water production, waste water treatment, ion exchanger, CO₂ separator, electrolyzer membranes, electrodialyzer, or food storage applications.

In embodiments, the membrane when used as the water purification membrane, helps in removing metals, e.g., copper, chromium, and the like from target water stream.

In embodiments, a flow battery comprises: a negative electrode, a positive electrode, and a membrane provided between the negative electrode and the positive electrode. The flow battery can be used as a power supply for electric vehicles, hybrid electric vehicles, or in power storage systems.

In embodiments, a composite comprises the curable composition and at least one electrically conducting filler, e.g., carbon black, graphene, single or multiwalled carbon nanotubes, and the like. The electrically conducting filler can be added in amounts of 1-40, or 5-30, or 10-35, or 1-20, or 1-10 wt. %, based on total weight of the composite. The composite can be used in the preparation of electrodes.

(Examples): The following examples are intended to be non-limiting.

The following test methods are used.

Fenton test was conducted using 3 wt. % hydrogen peroxide and FeSO₄·7H₂O solution (˜4 ppm Fe²⁺) as Fenton reagent. The membrane samples were exposed to the Fentons reagent at 65° C. for various time periods. After treatment, the membrane samples were rinsed with de-ionized water and used for further tests.

The viscoelastic behavior is measured by DMA according to ASTM 4065.

Mechanical properties, including toughness, Young's modulus, tensile strength, and elongation at break, in the dry and wet states are measured according to ASTM D412. For mechanical property measurements in the wet state, samples were equilibrated under water for a suitable period prior to test.

Proton conductivity measurements are performed by using potentiostat/

galvanostat and an impedance analyzer inside the DI water environment via electrochemical impedance spectroscopy (EIS). Impedance scans (Nyquist plots) are measured with open-circuit potential at a 10 mV amplitude over a frequency range from 1 MHz to 1 Hz at a temperature range from 25 to 80° C. Membrane (thickness of 50 μm) samples are equilibrated for at least 1 hour at each temperature followed by five measurements at the equilibrium condition. Proton conductivity is calculated using the following equation (I):

$$σ = L / AR \qquad ( I )$$

where L and A are the thickness and cross-section area of the sample, respectively, and the resistance R is determined from the equivalent circuit regression from the Nyquist plot.

The components used in examples include:

SSBC-1: A sulfonated penta block copolymer of the structure poly[tert-butylstyrene-b-(ethylene-propylene)-b-(styrene-co-styrene-sulfonate)-b-(ethylene-propylene)-tert-butylstyrene] (tBS-EP-sPS-EP-tBS) with 52% sulfonation. The tBS block each has a Mₚ of 15 kg/mol, the EP block each has a Mₚ of 12 kg/mol, the interior sPS block has a Mₚ of 22 kg/mol, and IEC of 2.0 meq of-SO₃H/g of polymer.

Polymeric polyol-1 (PyP-1) is a polyethylene glycol having molecular formula of (C₂H₄O)ₙH₂O, CAS No. 25322-68-3EC, and molecular weight (M_{w}) of 1000 g/mol.

Cross-linking agent is a bis[4-(glycidyloxy) phenyl]propane.

Radical scavenger is CeO₂.

(Example 1): Curable compositions were prepared by mixing the components in the amounts as shown Table 1 in toluene: 1-propanol mixture (1:1) to yield a 20 wt. % concentrated dispersion and left overnight to achieve complete dissolution. Membrane samples of 50 μm (2 mil) thickness each were prepared from the solution by automatic film applicator. Membranes were cured at 130° C. for 30 minutes. Curing conditions of the Examples are also shown in Table 1.

TABLE 1

| | SSBC-1 | PyP-1 | Cross-linking | Radical | Curing Temp. | Curing Time |
|---|---|---|---|---|---|---|
| Examples | (wt. %) | (wt. %) | agent (wt. %) | scavenger (wt. %) | (° C.) | (Min.) |
| SSBC-1 | 100 | — | — | — | — | — |
| Example 1a | 95 | 5 | — | — | 130 | 30 |
| Example 1b | 95 | — | 5 | — | 130 | 30 |
| Example 1c | 90 | 5 | 5 | — | 130 | 30 |
| Example 1d | 89.8 | 5 | 5 | 0.2 | 130 | 30 |

Membranes after curing (thickness of 60 μm) were subjected to aging (Fenton reagent) for different time periods at 65° C. Proton (H⁺) conductivity of aged membranes was measured in DI water at 60° C., and retention of proton conductivity is presented in table 2.

TABLE 2

| | | Proton conductivity (H⁺) | | |
|---|---|---|---|---|
| | Water gain at 80° C. | retention (%) | | |
| Examples | (wt. %) | Initial | 2 hours | 4 hours |
| SSBC-1 | 429 | 100 | 42 | 40 |
| Example 1a | 326 | 100 | — | 66 |
| Example 1b | 94 | 100 | 63 | 53 |
| Example 1c | 88 | 100 | — | 67 |

Membranes were also visually observed for stability over a period of time, with results as shown in Table 3.

TABLE 3

| Examples | 2 hours | 4 hours | 6 hours |
|---|---|---|---|
| SSBC-1 | Stable | Broken | NA |
| Example 1a | Stable | Unstable | Broken |
| Example 1b | Stable | Broken | NA |
| Example 1c | Stable | Stable | Unstable |
| Example 1d | Stable | Stable | Stable |

*NA = Not measured; and Unstable = Not completely stable but not reached a state of complete instability.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “includes” and its grammatical variants are intended to be non-limiting, such that recitation of items in a list is not to the exclusion of other like items that can be substituted or added to the listed items.

Unless otherwise specified, all technical and scientific terms used herein have the same meanings as commonly understood by one of skill in the art to which the disclosed disclosure belongs. The recitation of a genus of elements, materials, or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A polymer membrane formed from a curable composition comprising:
(a) 60 to 98 wt. % of a sulfonated hydrogenated styrenic block copolymer comprising:
at least one block “S” and at least one block “_{S}S,” each independently composed of vinyl aromatic units, and
at least one block “R” composed of hydrogenated diene units,
wherein the block “S” is resistant to sulfonation and the block “_{S}S” is susceptible to sulfonation having a degree of sulfonation of at least 10 mol %, and
wherein the sulfonated hydrogenated styrenic block copolymer has an ion exchange capacity (IEC) of at least 0.5 meq/g;
(b) 1 to 20 wt. % of a hydroxyl group containing compound selected from the group consisting of diols, triols, tetraols, polyols, polymeric polyols, and mixtures thereof;
(c) at least 1 wt. % of a cross-linking agent containing an epoxy-based compound; and
(d) up to 5 wt. % of a radical scavenger; and
wherein the polymer membrane, after curing, retains a proton conductivity of >55% after aging in Fenton's reagent for 4 hours at 65° C., relative to the proton conductivity of the polymer membrane before aging, measured at 60° C.

2. The polymer membrane of claim 1, wherein the polymer membrane has a weight gain of <70 wt. %, after immersion for 24 hours in DI water at 25° C., measured at 25° C.

3. The polymer membrane of claim 1, wherein the polymer membrane has a weight gain of <350 wt. %, after immersion for 24 hours in DI water at 80° C., measured at 25° C.

4. The polymer membrane of claim 1, wherein the polymer membrane has a retention of a proton conductivity of >60% after aging in Fenton's reagent for 4 hours at 65° C., relative to the proton conductivity of the polymer membrane before aging, measured at 60° C.

5. The polymer membrane of claim 1, wherein the cross-linking agent is a glycidyl ether selected from the group consisting of monoglycidyl ether, diglycidyl ether, triglycidyl ether, tetraglycidyl ether, pentaglycidyl ether, hexaglycidyl ether, octaglycidyl ether, polyglycidyl ether, and mixtures thereof.

6. The polymer membrane of claim 5, wherein the cross-linking agent is a diglycidyl ether; and wherein the diglycidyl ether is selected from any of bisphenol F diglycidyl ether, ethylene glycol diglycidyl ether, resorcinol diglycidyl ether, 1,4-butanediol diglycidyl ether, diglycidyl ether, 1,3-diglycidyl glyceryl ether, bis[4-(glycidyloxy)phenyl]propane, resorcinol diglycidyl ether, neopentyl glycol diglycidyl ether, ethyleneglycol diglycidyl ether, propyleneglycol diglycidyl ether, diethyleneglycol diglycidyl ether, hexanediol diglycidyl ether, triethyleneglycol diglycidyl ether, dipropyleneglycol diglycidyl ether, tripropyleneglycol diglycidyl ether, polypropyleneglycol diglycidyl ether, diglycidylether of cyclohexane dimethanol, and isosorbide diglycidyl ether.

7. The polymer membrane of claim 1, wherein the hydroxyl group containing compound is selected from the group consisting of diols, triols, tetraols, polyols, and mixtures thereof; and wherein the hydroxyl group containing compound has a molar mass of <0.5 kg/mol.

8. The polymer membrane of claim 1, wherein the hydroxyl group containing compound is a polymeric polyol having a weight average molecular weight (M_{w}) of 0.5 to 30 kg/mol.

9. The polymer membrane of claim 8, wherein the polymeric polyol is a polyethylene glycol.

10. The polymer membrane of claim 1, wherein the curable composition comprises 0.01 to 5 wt. % of a radical scavenger, based on total weight of the curable composition.

11. The polymer membrane of claim 10, wherein the radical scavenger is a metal-based compound selected from the group consisting of tungsten (W), ruthenium (Ru), palladium (Pd), silver (Ag), rhodium (Rh), cerium (Ce), zirconium (Zr), yttrium (Y), manganese (Mn), molybdenum (Mo), lead (Pb), vanadium (V), titanium (Ti), and mixtures thereof.

12. The polymer membrane of claim 11, wherein the metal based compound is cerium (Ce).

13. The polymer membrane of claim 1, wherein the sulfonated hydrogenated styrenic block copolymer has a general structure of: S-_{S}S-S, (S-_{S}S)ₙ(S), (S-_{S}S-S)ₙ, (S-_{S}S-S)ₙX, (S-_{S}S)ₙX, S-_{S}S-R, S-R-SS-R-S, S-_{S}S-R-_{S}S-S, (S-R-_{S}S)ₙS, (S-_{S}S-R)ₙS, (S-R-_{S}S)ₙX, (S-SS-R)ₙX, (S-R-_{S}S-R-S)ₙX, (S-_{S}S-R-_{S}S-S)ₙX, and mixtures thereof; wherein n is an integer from 2 to 30; and X is residue of a coupling agent.

14. The polymer membrane of claim 1, wherein each block “S”, “_{S}S”, and “R” independently has a Mₚ of >5 kg/mol.

15. The polymer membrane of claim 1, wherein the block “_{S}S” has a degree of sulfonation of 15 to 95 mol %, based on total mole of the block “_{S}S”.

16. The polymer membrane of claim 1, wherein the sulfonated hydrogenated styrenic block copolymer has an ion exchange capacity (IEC) of 0.5 to 3.5 meq/g.

17. The polymer membrane of claim 1, wherein the sulfonated hydrogenated styrenic block copolymer has a Mₚ of 20 to 300 kg/mol.

18. The polymer membrane of claim 1, wherein the polymer membrane has a thickness of 1 to 400 μm.

19. A composite membrane is obtained by coating the curable composition of claim 1 on to a microporous substrate;
wherein the microporous substrate is selected from the group consisting of polyolefin, polysulfone, polyimide, polytetrafluoroethylene, polyetheretherketone, polyamideimide, polyester, cellulose, cellulose nitrate, cellulose acetate, a fibrous woven or a non-woven material, polytetrafluoroethylene, and combinations thereof.

20. A polymer membrane formed from a composition comprising:
(a) a sulfonated hydrogenated styrenic block copolymer comprising:
at least one block “S” and at least one block “_{S}S,” each independently composed of vinyl aromatic units, and
at least one block “R” composed of hydrogenated diene units, wherein the block “S” is resistant to sulfonation and the block “_{S}S” is susceptible to sulfonation having a degree of sulfonation of at least 10 mol %, and
wherein the sulfonated hydrogenated styrenic block copolymer has an ion exchange capacity (IEC) of at least 0.5 meq/g; and
(b) a metal cation selected from the group consisting of divalent metal cations, trivalent metal cations, polyvalent metal cations, and mixtures thereof.
